(19) United States
(12) Patent Application Publication
(10) Pub. No.: US 2002/0078448 A1
(43) Pub. Date: Jun. 20, 2002

(54) Information processing device and method, and recording medium

(76) Inventor: Tatsuya Wakahara, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/931,798

(22) Filed: Aug. 17, 2001

(30) Foreign Application Priority Data
Aug. 25, 2000 (JP) P2000-256252

(51) Int. Cl. H04N 5/445; G06F 13/00

(52) U.S. Cl. 725/39; 725/40; 725/47; 725/44

(57) ABSTRACT

In a program table displayed on the screen of a television receiver, past programs (programs which already have been broadcast), programs currently being broadcast and future programs (programs which will be broadcast) are displayed with different colors so as to be distinguishable from one another. A selected program frame is displayed with still another color. When the selected program frame is a program currently being broadcast, the display is switched to the selected program, and when it is a future program, a process of programming the recording of the selected program is executed.

### CROSS-REFERENCE TO RELATED APPLICATIONS

The present application claims priority from Japanese Application No. P2000-256252 filed on Aug. 25, 2000, the disclosure of which is hereby incorporated by reference herein.

### BACKGROUND OF THE INVENTION

The present invention relates to an information processing device and method, and a recording medium, and particularly to an information processing device and method and a recording medium which are suitably used for a device for supplying an EPG.

Recently, digital broadcasts have become popular. In digital broadcasts, many channels exist, and many programs are distributed. Therefore, it is difficult for users to select (find out) programs which the users want to watch/listen to. Accordingly, a program table called an EPG (Electric Program Guide) is supplied (distributed) to the users as a method of enabling the users to easily select programs which the users want to watch/listen to. An example of an EPG is shown in FIG. 1. As shown in FIG. 1, programs on every channel are displayed in a time frame position corresponding to the distribution time.

A user can select and watch/listen to or program to record a desired program from such an EPG.

As shown in FIG. 1, programs are displayed as a list in the EPG. In such a display, when the number of programs increases, it may be difficult to select a desired program. Therefore, there is known an EPG in which programs are classified by category (for example, sport, and drama) and these programs are displayed with different colors in accordance with the above classification.

Further, in the EPG shown in FIG. 1, programs currently being broadcast, programs that already have been broadcast and programs which will be broadcast are displayed together with one another. In addition, each program is different in broadcast time period, and thus different in the length between time frames to be displayed. In such a condition, the respective programs are displayed as being irregularly arranged as shown in FIG. 1, so that there may occur a situation in which a program that already has been broadcast is selected as a program which a user wants to watch/listen to, or the recording of a program currently being broadcast is programmed because a user misunderstands that it will be broadcast in the future. This could not be prevented even if the above programs are displayed with different colors among different categories.

In order to avoid this problem, the user must compare the current time and the broadcast time of a program to check whether a program which the user wants to watch/listen to already has been broadcast or whether a program which the user wants to program to record is a program that will be broadcast, and thus conventional EPG is inconvenient for use.

### SUMMARY OF THE INVENTION

The present invention has an object to supply an EPG in which a program currently being broadcast, a program that already has been broadcast and a program that will be broadcast can be distinguished from one another at a glance.

An information processing device for displaying an electronic program guide according to the present invention includes a display including representations of a past program whose broadcast time is prior to a present time, a present program whose broadcast time contains the present time and a future program whose broadcast time is subsequent to the present time, the representation of the past program being in a first color, the representation of the present program being in a second color different from the first color, and the representation of the future program being in a third color different from the first and second colors.

A representation of a program selected by a user may be displayed in a fourth color different from the first, second and third colors.

A method for controlling the display of an electronic program guide according to the present invention includes displaying in a first color a representation of a past program whose broadcast time is prior to a present time; displaying in a second color different from the first color a representation of a present program whose broadcast time contains the present time; and displaying in a third color a representation of a future program whose broadcast time is subsequent to the present time, the third color being different from the first and second colors.

A recording medium according to the present invention is recorded with a computer-readable program for controlling the display of an electronic program guide. The program includes displaying in a first color a representation of a past program whose broadcast time is prior to a present time; displaying in a second color different from the first color a representation of a present program whose broadcast time contains the present time; and displaying in a third color a representation of a future program whose broadcast time is subsequent to the present time, the third color being different from the first and second colors.

In the information processing device, the display control method and the recording medium according to the present invention, representations of a past program whose broadcast time is prior to a present time, a present program whose broadcast time contains the present time and a future program whose broadcast time is subsequent to the present time are controlled to be displayed with different colors. Accordingly, there can be prevented misoperations in which a user erroneously instructs to watch/listen to a past program which already has been broadcast or to program the recording of a past program.

### BRIEF DESCRIPTION OF THE DRAWINGS

FIG. 1 is a diagram showing an example of a conventional EPG;

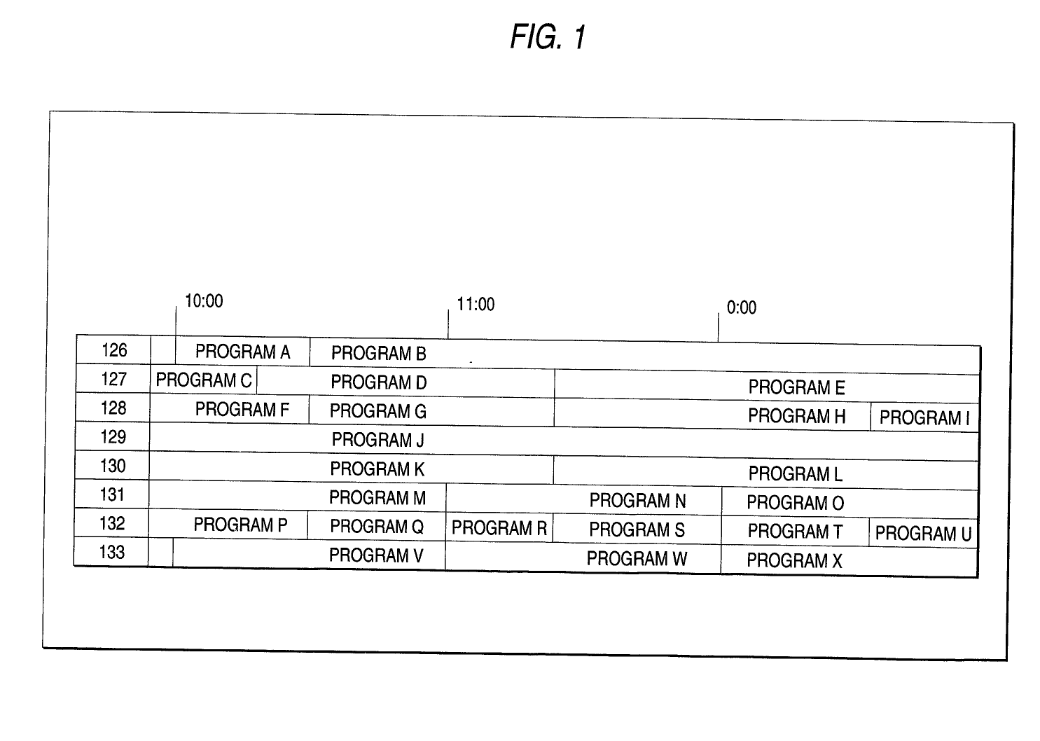

FIG. 2 is a diagram showing the construction of an embodiment of a receiver to which the present invention is applied;

FIG. 3 is a flowchart showing the operation of the receiver 10;

FIG. 4 is a diagram showing a display example of the EPG displayed in step S1; and

FIG. 5 is a diagram showing a medium.

### DETAILED DESCRIPTION

A preferred embodiment of the present invention will be described with reference to the accompanying drawings.

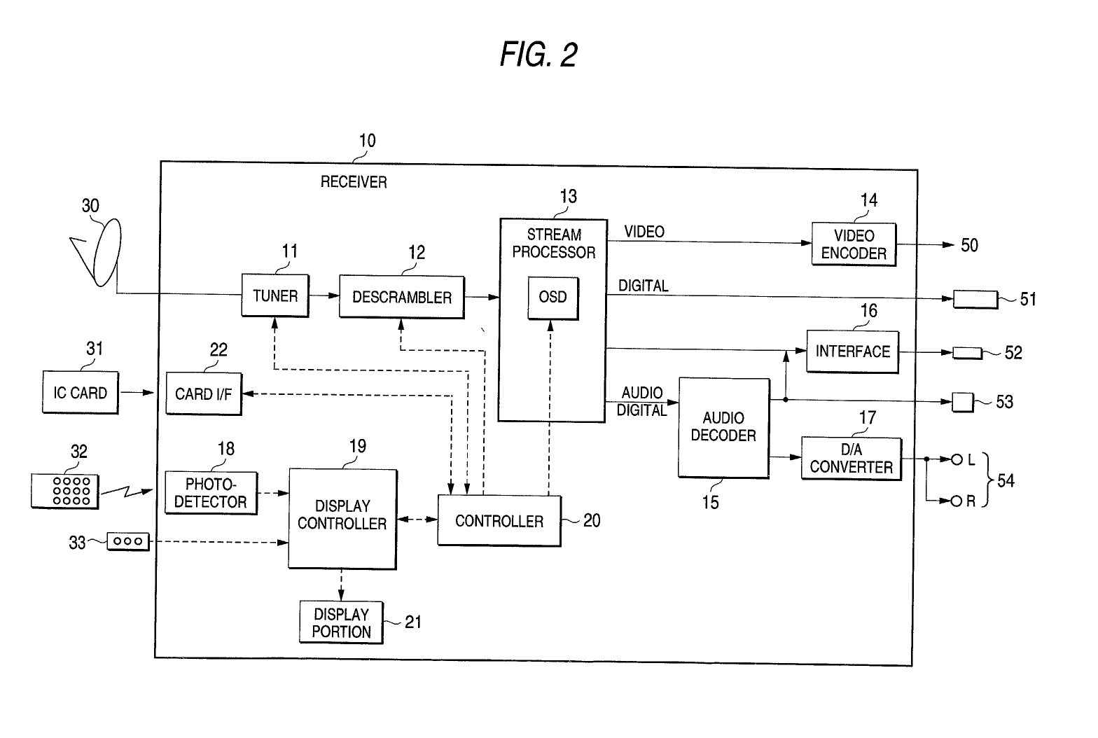

FIG. 2 is a diagram showing the construction of an embodiment of a receiver 10 to which the present invention is applied. Digital data received from an antenna 30 are input to a tuner 11 of the receiver 10. The tuner 11 extracts data on a program indicated by a user and outputs the data to a descrambler 12.

When input data are scrambled and when the scramble is allowed to be descrambled (for example, a regular subscription is taken out, and thus a descramble key is kept), the descrambler 12 descrambles the scramble and outputs the data to a stream processor 13. The stream processor 13 outputs video data of the input data to a video encoder 14, and also outputs audio data of the input data to an audio decoder 15. When the video data are encoded data, the stream processor 13 subjects the input video data to decode processing corresponding to the encode system, further generates OSD (On Screen Display) data if occasion demands, superposes the OSD data on the decoded video data and then outputs the data thus obtained.

When the video encoder 14 outputs input video data to a television receiver 50, the video encoder 14 subjects the input video data to encode processing meeting the television receiver 50, for example, encode processing based on the NTSC (National Television System Committee) system, and then outputs the data to the television receiver 50. The video data processed by the stream processor 13 are also output to a component 51 treating digital data.

The audio decoder 15 subjects the input audio data to decode processing corresponding to the encode system of the audio data. The audio data which have been subjected to the decode processing by the audio decoder 15 are output to an interface 16. The interface 16 is connected to IEEE1394 cable 52, for example, and outputs the audio data from the audio decoder 15 to a device connected to the IEEE1394 cable 52.

The audio data output from the audio decoder 15 are also output to other devices through an optical cable 53. Further, the audio data output from the audio decoder 15 are converted to analog data by a D/A (Digital/Analog) converter 17, and output to a speaker 54.

The tuner 11 extracts the data of a program indicated by the user. The user tunes a desired program by using a remote controller 32 or switch 33, and outputs an instruction. The switch 33 is provided on the side surface of the receiver 10, and it is designed to output substantially the same instruction as the remote controller 32. The remote controller 32 receives/transmits data from/to the receiver 10 by infrared rays, for example.

The data corresponding to an instruction which the user makes by using the remote controller 32 are received by a photodetector 18 of the receiver 10. The data received by the photodetector 18 or the data corresponding to the instruction based on the switch 33 are output to a display controller 19. The display controller 19 outputs the data from the photodetector 18 or the data from the switch 33 to a controller 20 if occasion demands, and also performs the display control of a display portion 21 according to the input data.

The display portion 21 is provided on the side surface of the receiver 10, and it makes a display to let the user know that processing corresponding to the user's instruction is being executed or makes a display for information to be supplied to the user.

When a subscription to watch a pay program is taken out, data supplied from a partner with which the subscription is taken out is stored in an IC card 31. This data is a descrambling key for descrambling the scramble or the like. The IC card 31 is mounted in a card I/F (Interface) 22 so that recorded data may be read out. The data thus read out are output to the controller 20.

On the basis of the input data, the controller 20 outputs an indication of a program to be extracted to the tuner 11, and also supplies the descrambling key to the descrambler 12.

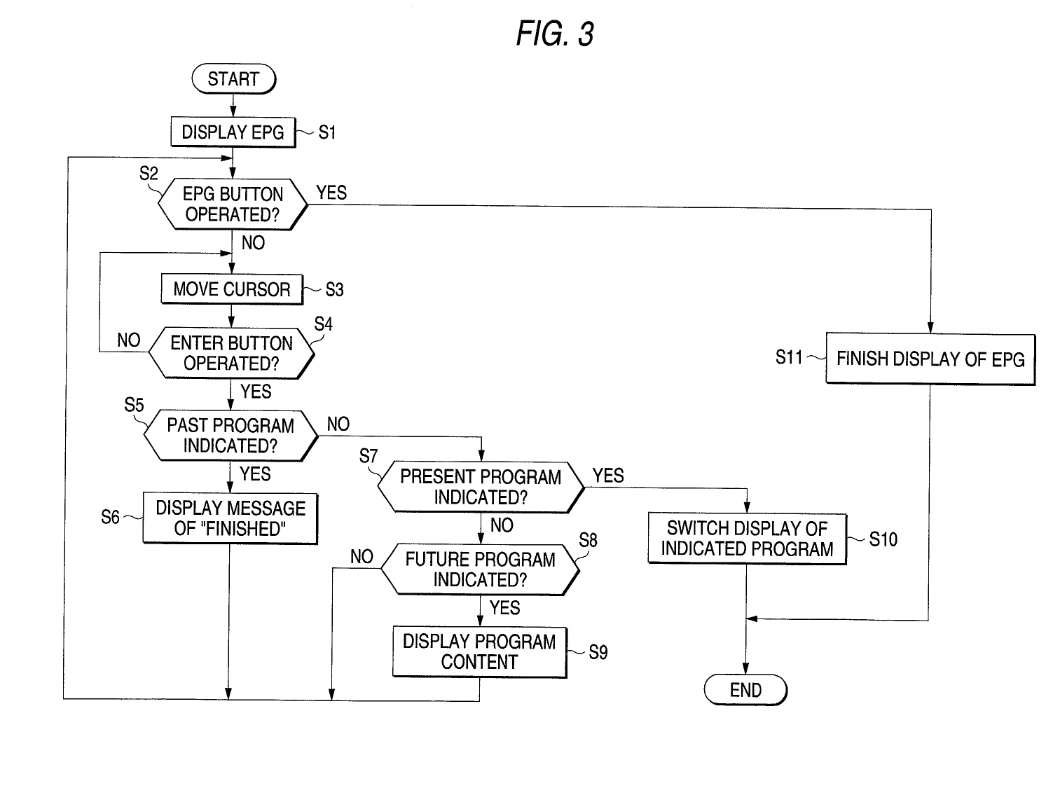

Next, the operation of the receiver 10 when a user refers to an EPG to select a desired program or program picture recording of a desired program will be described with reference to the flowchart of FIG. 3. In step S1, the receiver 10 displays the EPG on the television receiver 50, for example. The display of the EPG is carried out on the basis of an instruction from a user. The user instructs the display of the EPG by operating a remote controller 32 or switch 33 when a predetermined channel program is displayed or the like. In this case, the following description will be made on the assumption that an EPG button (not shown) is provided on the remote controller 32 for instructing switching to the display of the EPG.

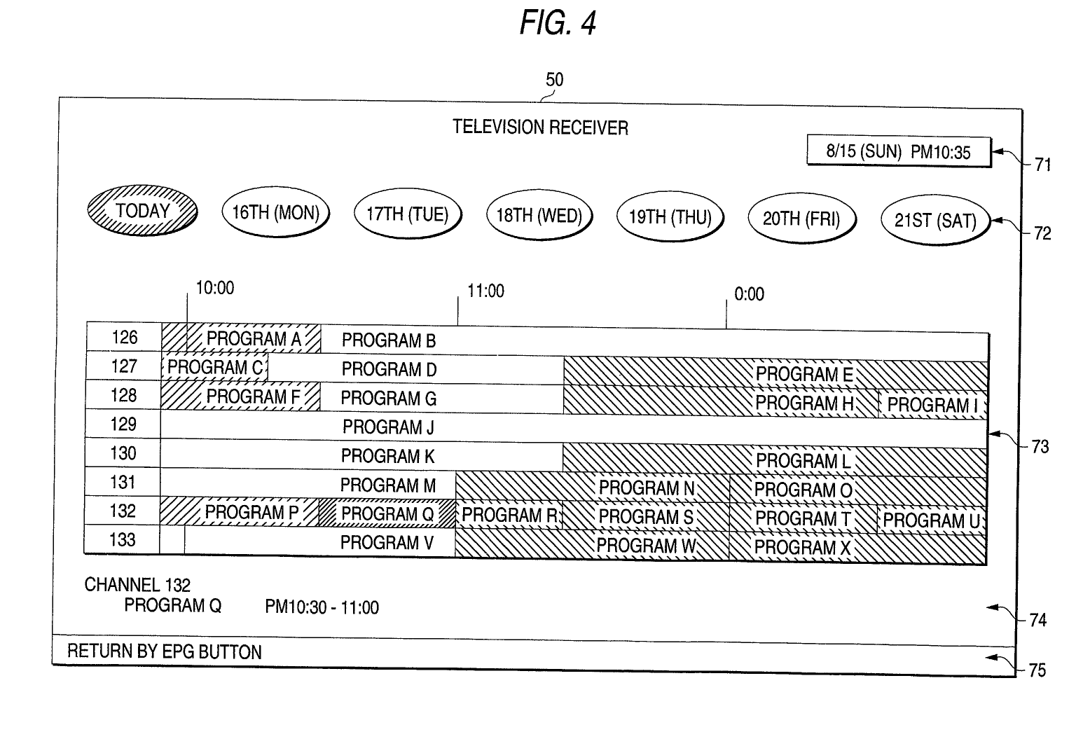

FIG. 4 shows an example of an EPG displayed on the television receiver 50 by the user's operation of the EPG button provided on the remote controller 32 according to step S1. A present date and hour display portion 71 for displaying the present date and hour is provided at the upper side of the screen of the television receiver 50. A day-of-week display portion 72 for displaying the present day of the week is provided below the present date and hour display portion 71. Further, a program-table display portion 73 is provided below the day-of-week display portion 72.

Each day of the week displayed on the day-of-week display portion 72 is set as a button, and the programs of the day of the week corresponding to the operated button are displayed on the program-table display portion 73. In the display example shown in FIG. 4, programs within a three-hour time period containing the present time on a selected day of the week are displayed on the program-table display portion 73 in the corresponding time frames for every channel (numerals displayed at the left side of the program-table display portion 73).

The program-table display portion 73 displays a program table so that past programs with respect to the present time (programs that already have been broadcast), programs currently being broadcast and future programs with respect to the present time (programs that will be broadcast) are distinguished from one another at a glance. In the display example of FIG. 4, the past programs and the future programs are displayed with oblique lines. Different oblique lines are affixed to the past programs and the future programs. In FIG. 4, they are distinguished by the oblique lines, however, they may be distinguished by color.

When the distinction is made by color, the past programs, the present programs and the future programs are displayed with different colors. The colors may be set to the user's favorite colors.

A cursor moving within the displayed program table is also displayed on the program-table display portion 73. A program frame at which the cursor is located is displayed so as to be distinguishable from the other program frames. For example, when the past programs, the present programs and the future programs are displayed so as to be distinguishable from one another by color, a program at which the cursor is located is displayed with a further different color. In the display example of FIG. 4, the cursor is located on a program Q of channel 132. The cursor is operated by using the remote controller 32.

As described above, the past programs, the present programs and the future programs are displayed so as to be distinguishable from one another at a glance, thereby preventing the occurrence of a situation in which a past program which already has been broadcast is selected as a program which the user wants to watch/listen to or a program currently being broadcast is selected as a program for which recording is programmed.

If time elapses while the program table displayed on the program-table display portion 73 is kept in a display state, the program table will be shifted to the left side, for example, at 11 o'clock in the display example shown in FIG. 4, and will be renewed to a program table from 11 o'clock to 2 o'clock. With this operation, the latest program table containing the current time is displayed at all times. Further, this will prevent the case where past programs continue to be displayed.

The information of a program at which the cursor is located in the program-table display portion 73 is displayed on the program information display portion 74. A channel number, a program title, a broadcast time, a program content, etc. are provided as the information of the program to be displayed. An operation guide display portion 75 is provided near the bottom of the program information display portion 74. The operation guide display portion 75 displays information on the operations. For example, it shows a user that the display will be returned (switched) to a previous state if the user operates the EPG button provided on the remote controller 32.

When the EPG (program table) as described above is displayed on the television receiver 50 in step S1, it is judged in step S2 whether the EPG button has been operated. If it is judged in step S2 that the EPG button has not been operated, the process goes to step S3 to move the cursor in conformity with the user's operation of the remote controller 32. Then, it is judged in step S4 whether the enter button has been operated. The enter button is also provided on the remote controller 32, and it is a button to be operated when the user wants to watch/listen to a program at which the cursor is located or the user wants to program the recording of the program.

The process of the steps S3 and S4 is repetitively carried out until it is judged in step S4 that the enter button has been operated. If it is judged that the enter button has been operated, the process goes to step S5. It is judged in step S5 whether the program at which the cursor is located when the enter button has been operated is a past program. Since past programs, present programs and future programs are displayed with different colors as described above, they are distinguishable from one another at a glance. However, there may be a situation in which a user erroneously selects (indicates) a past program which already has been broadcast. In order to accommodate such a situation, the process of the steps S5 and S6 is provided.

If it is judged in step S5 that a past program has been indicated, the process goes to step S6 in which a message to make the user recognize that the indicated program already has been broadcast and thus cannot be selected, like “broadcast has been finished”, is displayed on the screen of the television receiver 50. This message may be displayed so as to be overlapped with the display frame shown in FIG. 4 or it may be displayed after the display frame is switched.

If the message in the step S6 is displayed for only a predetermined time or if the user carries out an operation indicating the user's recognition that the program cannot be selected, the process returns to step S2 to repeat the process of the subsequent steps.

On the other hand, if it is judged in step S5 that no past program has been indicated, the process goes to step S7 to judge whether a present program has been indicated. If it is judged that no present program has been indicated, the process goes to step S8 to judge whether a future program has been indicated. If it is judged in step S8 that a future program has been indicated, the process goes to step S9.

The judgment of the indication of a future program makes it possible to judge that the user desires to program the recording of the indicated program, and thus the content of the indicated program is first displayed in step S9. This display may be made on the program information display portion 74, or the display frame may be switched to another for displaying detailed information. When the user wants to program the recording of the program by referring to the program information thus displayed, the user executes a predetermined operation, for example, operating a picture-recording programming button provided on the remote controller 32 or operating a picture-recording programming button displayed on the screen, whereby the picture recording is programmed on the basis of the operation.

On the other hand, if it is judged in step S8 that no future program has been indicated, the process returns to the step S2 to repeat the process of the subsequent steps. If it is judged in step S8 that the program is not a future program, it has been judged that the program concerned is not contained in any time of the past, the present or the future. Such a program is processed as a program having no time information. In other words, since the user can do neither watching/listening of the program concerned nor programming of the recording of the program concerned, no special processing is carried out, and the display state of the display frame as shown in FIG. 4 is kept (that is, the process returns to step S2 to repeat the process of the subsequent steps).

On the other hand, if it is judged in step S7 that a present program has been indicated, the process goes to step S10. In step S10, the display is switched to the program thus indicated. The indication of the present program makes it possible to judge that the user wants to watch/listen to the program concerned, and thus the display is switched from the display state of the EPG as shown in FIG. 4 to the program indicated.

On the other hand, if it is judged in step S2 that the EPG button has been operated, that is, it is judged that the user has instructed to finish the display of the EPG, the process goes to step S11 to finish the display of the EPG shown in FIG. 4. When the display of the EPG is finished, the display of the television receiver 50 is switched to an original program (a program of a channel displayed before the EPG was displayed).

As described above, the past, present and future programs are displayed with different colors so as to be distinguishable from one another in the EPG display, and also the process is executed in accordance with the broadcast time of a selected program, whereby the user can be prevented from executing an operation that cannot be performed, and also the user can easily carry out a desired operation.

The series of processes+ described above can be executed by hardware, however, it may be executed by software. When the series of processes is executed by software, the program constituting the software may be installed from a recording medium into a computer installed in special-purpose hardware or a general personal computer which can execute various functions by installing various programs therein.

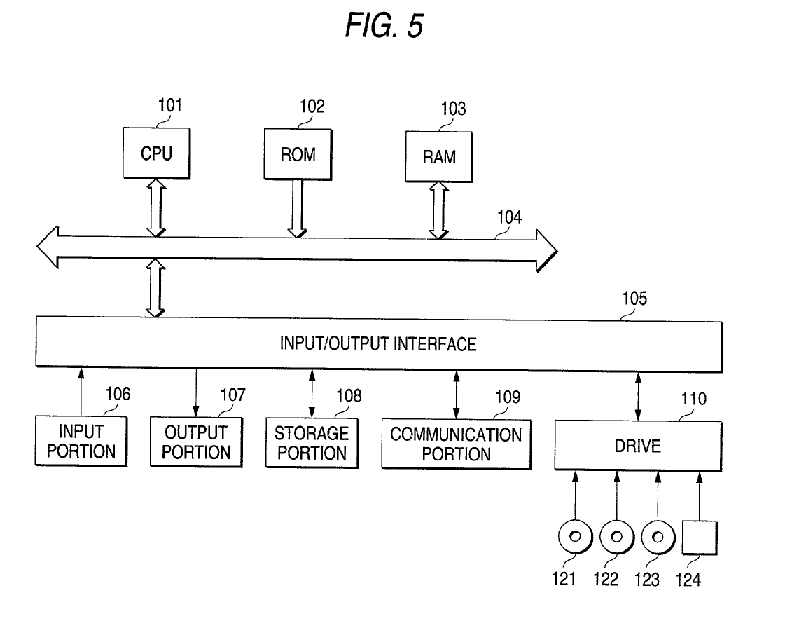

As shown in FIG. 5, this recording medium is constructed by not only a packaged medium comprising a magnetic disc 121 (such as a floppy disk), an optical disc 122 (such as a CD-ROM (Compact Disc-Read Only Memory) or DVD (Digital Versatile Disk)), a magnetooptical disc 123 (such as an MD (Mini-Disk)), a semiconductor memory 124 or the like that has the program recorded therein and is distributed to supply the program to users separately from a computer, but also by a hard disk containing a ROM 102 or a storage portion 108 that has the program recorded therein and is supplied to users under the state that it is installed in a computer in advance.

In this specification, the step describing the program to be supplied through the medium includes not only processing that is carried out in time series according to the described order, but also processing that is not carried out in time series, but in parallel or individually.

In this specification, the system represents the overall device constructed by plural devices.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information processing device for displaying an electronic programming guide, comprising
a display including representations of a past program whose broadcast time is prior to a present time, a present program whose broadcast time contains said present time and a future program whose broadcast time is subsequent to said present time, said representation of said past program being in a first color, said representation of said present program being in a second color different from said first color, and said representation of said future program being in a third color different from said first and second colors.

2. The information processing device as claimed in claim 1, said display further includes a representation of a program selected by a user, said representation of said selected program being displayed in a fourth color different from said first, second and third colors.

3. The information processing device as claimed in claim 2, further comprising a cursor, said cursor being located on said representation of said program selected by the user.

4. The information processing device as claimed in claim 1, wherein said first, second and third colors are set according to the user's favorite colors.

5. The information processing device as claimed in claim 1, wherein said display always includes a latest electronic program guide containing said present time.

6. A method for controlling the display of an electronic program guide, comprising:
displaying in a first color a representation of a past program whose broadcast time is prior to a present time;
displaying in a second color different from said first color a representation of a present program whose broadcast time contains said present time; and
displaying in a third color a representation of a future program whose broadcast time is subsequent to said present time, said third color being different from said first and second colors.

7. The method as claimed in claim 6, further comprising:
selecting a program; and
displaying in a fourth color a representation of said selected program, said fourth color being different from said first, second and third colors.

8. The method as claimed in claim 7, wherein said selecting step includes locating a cursor on said representation of said selected program.

9. The method as claimed in claim 6, wherein said first, second and third colors are set according to a user's favorite colors.

10. The method as claimed in claim 6, wherein said displaying steps display said electronic program guide so that a latest electronic program guide containing said present time is displayed at all times.

11. A recording medium recorded with a computer-readable program for controlling the display of an electronic program guide, the program comprising:
displaying in a first color a representation of a past program whose broadcast time is prior to a present time;
displaying in a second color different from said first color a representation of a present program whose broadcast time contains said present time; and
displaying in a third color a representation of a future program whose broadcast time is subsequent to said present time, said third color being different from said first and second colors.

12. The recording medium as claimed in claim 11, wherein said program further comprises:
selecting a program; and
displaying in a fourth color a representation of said selected program, said fourth color being different from said first, second and third colors.

13. The recording medium as claimed in claim 12, wherein said selecting step includes locating a cursor on said representation of said selected program.

14. The recording medium as claimed in claim 11, wherein said first, second and third colors are set according to a user's favorite colors.

15. The recording medium as claimed in claim 11, wherein said displaying steps display said electronic program guide so that a latest electronic program guide containing said present time is displayed at all times.
